(19) United States
(12) Patent Application Publication
(10) Pub. No.: US 2008/0152327 A1
(43) Pub. Date: Jun. 26, 2008

(54) Apparatus and method for controlling motor

(75) Inventors: Kwang Kyo Oh, Gwangju (KR); Hamaoka Koji, Gwangju (KR); Han Joo Yoo, Gwangju (KR); Pyeong Ki Park, Gwangju (KR); Jeong Ho Seo, Gwangju (KR); Hun Yub Bae, Gwangju (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/892,404

(22) Filed: Aug. 22, 2007

(30) Foreign Application Priority Data
Dec. 21, 2006 (KR) 10-2006-0132170

(51) Int. Cl. H02P 7/285

(52) U.S. Cl. 388/815

(57) ABSTRACT

An apparatus and method for controlling a motor, which are capable of accurately controlling a speed of the motor regardless of whether an error occurs in a clock circuit of the apparatus. It is possible to accurately control a speed of the motor regardless of a time error of the clock circuit, which occurs due to a use condition or long-term use, by driving the motor according to an input speed signal, detecting a driving waveform of the driven motor, synchronizing the detected driving waveform with the speed signal, and controlling the speed of the motor.

### CROSS-REFERENCE TO RELATED APPLICATIONS

This application claims the benefit of Korean Patent Application No. 10-2006-0132170, filed on Dec. 21, 2006 in the Korean Intellectual Property Office, the disclosure of which is incorporated herein by reference.

### BACKGROUND OF THE INVENTION

1. Field of the Invention

The present invention relates to an apparatus and method for controlling a motor. More particularly, to an apparatus and method for controlling a motor, which are capable of accurately controlling a speed of the motor regardless of whether an error occurs in a clock circuit.

2. Description of the Related Art

Generally, when a speed signal for specifying a speed of a conventional motor, such as a brushless DC (BLDC) motor, is input, the speed of the motor can be controlled by allowing a microcomputer for controlling the motor to output a control signal corresponding to the speed signal, detecting a current speed of the motor driven by the output control signal to obtain an error of the speed signal, feeding back the error to the microcomputer, and allowing the microcomputer to control an input signal of the motor so as to compensate the error of the speed signal.

The externally input speed signal may be implemented in a variety of methods. In conventional electric appliances using a motor controlling apparatus, a method of using a periodical signal proportional to a rotational speed of the motor has been mainly used.

Accordingly, in order to measure a period of the input speed signal, to generate a motor drive signal corresponding to the speed signal and to detect the speed of the motor to obtain the error of the speed signal, means for measuring time must be included in the motor controlling apparatus.

In a microcomputer which is recently developed, a clock circuit is generally included as the means for measuring the time. In a case of a built-in clock circuit, the error may become severe according to a driving voltage and an operation temperature of the microcomputer. Accordingly, a frequency of the input speed signal varies and thus the speed of the motor cannot be accurately controlled. Thus, unnecessary power consumption, noise and vibration may occur.

Accordingly, in order to solve the above-described problems, the means for measuring the time is separately provided in the motor controlling apparatus, thereby accurately controlling the speed. Even in this case, in the electric appliances which require the motor driving apparatus, material cost increases. When the clock circuit deteriorates, and thus, precision of the clock circuit deteriorates, the same problems as the built-in clock circuit may occur.

### SUMMARY OF THE INVENTION

Accordingly, it is an aspect of the present invention to provide an apparatus and method for controlling a motor, which are capable of accurately controlling a speed of the motor regardless of whether a time error occurs in a clock circuit due to a use condition or long-term use.

Additional aspects and/or advantages of the invention will be set forth in part in the description which follows and, in part, will be apparent from the description, or may be learned by practice of the invention.

The foregoing and/or other aspects can be achieved by providing an apparatus for controlling a motor which receives a speed signal for specifying a speed of the motor as a periodical signal, the apparatus including a driving waveform detection unit which detects a driving waveform of the motor, a clock circuit which measures periods of the speed signal and the driving waveform, and a control unit which drives the motor according to the received speed signal, synchronizing the driving waveform detected by the driving waveform detection unit with the speed signal using the periods of the speed signal and the driving waveform, which are measured by the clock circuit, and controlling the speed of the motor.

According to an aspect of the present invention, the speed signal is a pulse signal having a frequency that is proportional to the speed of the motor.

According to an aspect of the present invention, the driving waveform detection unit detects at least one of a current waveform and a voltage waveform input to the motor.

According to an aspect of the present invention, the clock circuit is a built-in clock circuit which is included in the control unit.

According to an aspect of the present invention, the control unit synchronizes the driving waveform with the speed signal of the motor based on a number of revolutions of the motor.

According to an aspect of the present invention, the control unit compares a first time corresponding to the number of the periods of the speed signal and a second time corresponding to the number of the periods of the driving waveform when the number of revolutions of the motor which is measured by the clock circuit is one and controls the speed of the motor according to the result of comparison.

According to an aspect of the present invention, the control unit decreases the speed of the motor when the first time is greater than the second time, increases the speed of the motor when the first time is less than the second time, and maintains the speed of the motor when the first time is identical to the second time.

It is another aspect of the present invention to provide a method for controlling a motor, the method including receiving a speed signal for specifying a speed of the motor as a periodical signal, driving the motor according to the received speed signal, detecting a driving waveform of the driven motor, and synchronizing the detected driving waveform with the speed signal and controlling the speed of the motor.

According to an aspect of the present invention, the speed signal is a pulse signal having a frequency that is proportional to the speed of the motor.

According to an aspect of the present invention, the detected driving waveform includes at least one of a current waveform and a voltage waveform input to the motor.

According to an aspect of the present invention, the synchronizing of the detected driving waveform includes synchronizing the driving waveform with the speed signal of the motor based on a number of revolutions of the motor.

According to an aspect of the present invention, the synchronizing of the detected driving waveform includes measuring a first time corresponding to the number of periods of the speed signal and a second time corresponding to the number of periods of the driving waveform when the number of revolutions of the motor is one, and comparing the first and second times which are measured in the measuring of the first time and the second time and controlling the speed of the motor according to the result of comparison.

According to an aspect of the present invention, the comparing of the first and second times includes decreasing the speed of the motor when the first time is greater than the second time, increasing the speed of the motor when the first time is less than the second time, and maintaining the speed of the motor when the first time is identical to the second time.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating an apparatus for controlling a motor according to an embodiment of the present invention;

FIG. 2 is a waveform diagram illustrating an externally input speed signal and a driving waveform of the motor, which are synchronized with each other according to an aspect of the present invention; and

FIG. 3 is a flowchart illustrating a method for controlling a motor according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

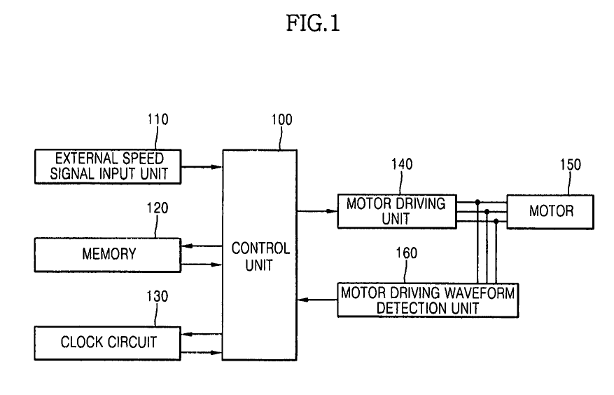

FIG. 1 is a block diagram illustrating an apparatus for controlling a motor according to an embodiment of the present invention. In the present embodiment, a three-phase 4-pole BLDC motor driven by an inverter circuit will be, for example, described. However, the present invention is not limited hereto.

When a speed signal for specifying a speed of a motor 150 is input to an external speed signal input unit 110, a control unit 100 transmits a control signal for driving the motor 150 to a motor driving unit 140.

At this time, the speed signal input to the external speed signal input unit 110 is a periodical signal having a frequency f1 proportional to a rotational speed V of the motor 150 as expressed by Equation 1 and is generally input in a form of a pulse signal.

f1=k*V Equation 1

For example, when the motor 150 is desired to rotate at a speed (V) of 50 revolutions per second (RPS) and a proportional constant k is 10, the speed signal is a pulse signal having a frequency of 500 Hz.

The speed signal is received from an external signal generator (not shown). The source of the external signal generator may vary. For example, the external signal generator may be a refrigerator control unit for controlling an internal temperature of a refrigerator. That is, when the internal temperature of the refrigerator is greater than or equal to a predetermined temperature, the refrigerator control unit transmits a speed signal for increasing the speed of the motor 150, which drives a compressor, to the predetermined speed to the external speed signal input unit 110.

In the present embodiment, the motor driving unit 140 corresponds to an inverter driving circuit in an inverter circuit and the control signal corresponds to a pulse width modulation (PWM) signal for controlling a plurality of switching units in the inverter circuit.

When the speed signal is input, the control unit 100 measures a period T1 (=1/f1) of the speed signal using a clock circuit 130 so as to obtain a target rotational speed V of the motor 150 and generates the control signal for driving the motor 150 at the obtained rotational speed V using information stored in a memory 120.

At this time, according to an embodiment of the present invention, the clock circuit 130 is used to measure time and is implemented by any one of a method of using crystal, a method of using a ceramic resonator and a method of using an RC oscillating circuit, for example. In the present embodiment, an external clock circuit 130 is separately used. Alternatively, in order to reduce material cost, a built-in clock circuit 130 which is included in the control unit 100 may be used. According to an embodiment of the present invention, the control unit 100 is a general microcomputer.

The motor driving unit 140 drives the motor 150 according to the transmitted control signal. When the motor 150 is driven, a motor driving waveform detection circuit 160 detects and transmits a driving waveform of the motor 150 to the control signal 100.

The control unit 100 measures a period T2 (=1/f2) of the transmitted driving waveform using the clock circuit 130 and controls the speed of the motor 150 based on the period of the driving waveform.

According to an embodiment of the present invention, the driving waveform of the motor 150 is at least one of phase current and phase voltage input to the motor 150. According to an embodiment of the present invention, a device and method for detecting the driving waveform is implemented by any one of well-known methods and thus the detailed description thereof will be omitted.

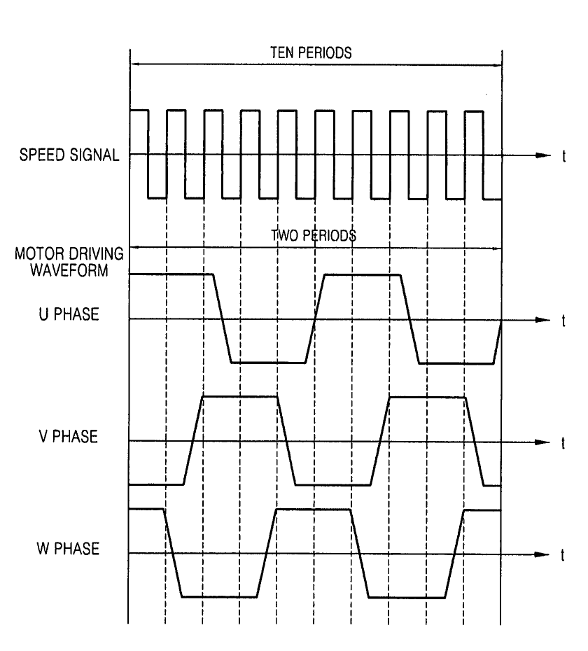

FIG. 2 is a graph illustrating the externally input speed signal and the driving waveform of the motor 150, according to the embodiment of the present invention, which shows a state that the speed signal is synchronized with the driving waveform based upon one revolution of the motor 150. That is, a case where the rotational speed of the motor is accurately controlled.

Since the number of mechanical revolutions and the number of electrical revolutions of the motor 150 have a relationship expressed by Equation 2, the rotational speed V of the motor 150, which is related to the mechanical revolution, and a frequency f2 of the motor driving waveform, which is related to the electrical revolution, have a relationship expressed by Equation 3. According to an embodiment of the present invention, N indicates the number of poles of the motor 150.

Number of electrical revolutions of the motor=(N/2)*number of mechanical revolutions of the motor 150 Equation 2

f2=(N/2)*V Equation 3

Accordingly, when Equation 1 and Equation 3 are rearranged with respect to the rotational speed V and the frequency is expressed by the period, Equation 4 is obtained.

T1={N/(2*k)}*T2 Equation 4

When the proportional constant k is 10 and the three-phase 4-pole motor 150 is used in the present embodiment, the period T1 of the speed signal and the period T2 of the driving waveform have a relationship expressed by Equation 5.

5*T1=T2 Equation 5

According to an embodiment of the present invention, while two periods of the driving waveform of the motor 150 elapse, the motor 150 mechanically makes one revolution. Accordingly, when the speed signal is accurately controlled as shown in FIG. 2, ten periods of the speed signal are synchronized with two periods of the driving waveform during one mechanical revolution of the motor 150.

Accordingly, in an embodiment of the present invention, when the clock circuit 130 has the error, the speed is controlled by determining whether the speed signal is synchronized with the driving waveform based on the number of revolutions of the motor 150, instead of the absolute time which is measured by the clock circuit 130. Thus, in despite of the error of the clock circuit 130, the speed of the motor 150 to be controlled is accurately identical to the actual speed of the motor 150 when the speed signal is synchronized with the driving waveform.

Accordingly, when the speed of the motor 150 is controlled by the controlling method according to the present embodiment, it is possible to accurately control the speed of the motor 150, regardless of the error which occurs in the clock circuit 130, whether the external clock circuit 130 or the built-in clock circuit 130 included in the control unit 100 is used. In addition, when the built-in clock circuit 130 is used, it is possible to prevent the material cost from increasing due to the installation of the external clock circuit 130.

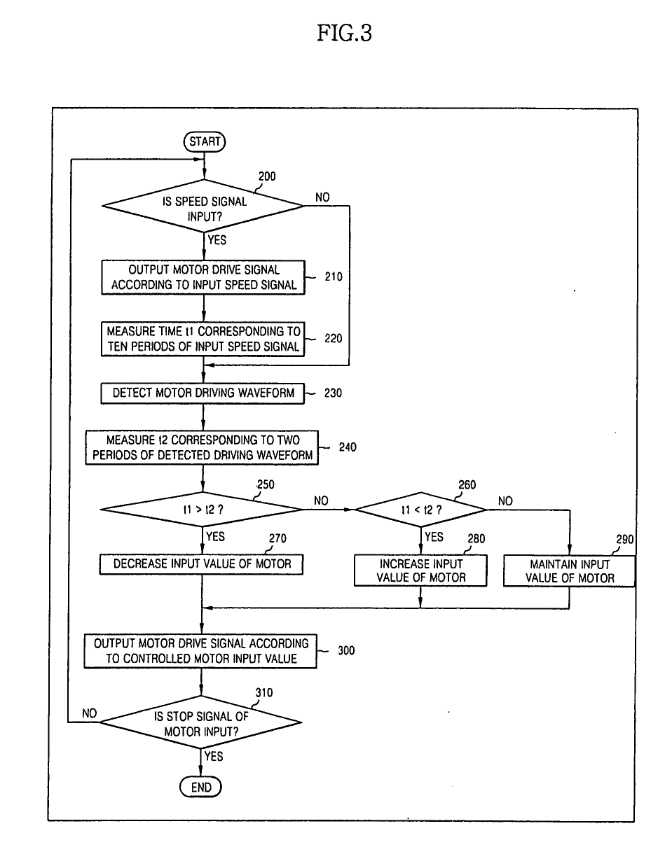

FIG. 3 is a flowchart illustrating a method for controlling a motor according to an embodiment of the present invention.

In operation 200, the control unit 100 determines whether a speed signal is input to the external speed signal input unit 110. When it is determined that the speed signal has been input in operation 200, the process moves to operation 210, where a motor drive signal which is a control signal for driving the motor 150 is output to the motor driving unit 140 so as to drive the motor 150.

From operation 210, the process moves to operation 220, where the control unit 100 measures a first time t1 corresponding to ten periods of the speed signal using the clock circuit 130.

In operation 220, the control unit 100 obtains the first time by multiplying the period T1 of the speed signal, which is measured when inputting the speed signal, by 10.

From operation 220, the process moves to operation 230, where the control unit 100 detects the motor driving waveform and proceeds to operation 240, where the control unit measures a second time t2 corresponding to two periods of the driving waveform detected by the motor driving waveform detection unit 160.

In operation 240, the control unit 100 can obtain the second time by multiplying the period T2 of the driving waveform, which is measured, by two.

From operation 240, the process moves to operation 250, where the control unit 100 compares the first time t1 with the second time t2. When it is determined that the first time t1 is greater than the second time t2, the process moves to operation 270, where the control unit 100 determines that the speed of the motor 150 is greater than a target speed corresponding to the speed signal and decreases an input value of the motor 150.

From operation 270, the process moves to operation 300, where the control unit 100 generates and outputs a motor drive signal according to the controlled input value of the motor 150 to the motor driving unit 140, thereby driving the motor 150.

On the other hand, then the first time t1 is not greater than the second time t2 in operation 250, the process move to operation 260, where the control unit 100 determines whether the first time t1 is identical to the second time t2. When it is determined that the second time t2 is greater than the first time t1, the process moves to operation 280, where the control unit 100 determines that the speed of the motor 150 is less than the target speed and increases the input value of the motor 150 and then performs operation 300.

When it is determined that the first time t1 is identical to the second time t2 in operation 260, the process moves to operation 290, where the control unit 100 determines that the motor 150 rotates at the target speed and maintains the input value of the motor 150 and then performs operation 300.

From operation 300, the process moves to operation 310, where the control unit 100 determines whether a stop signal of the motor is input. If it is determined that a stop signal of the motor in input, the controlling process is completed, and, otherwise, the controlling process returns to operation 200 and repeats the process.

When the speed signal is not input in operation 200, the control unit 100 performs operation 230.

As described above, by using an apparatus and method for controlling a motor according to an embodiment of the present invention, it is possible to accurately control a speed of the motor regardless of a time error of a clock circuit, which occurs due to a use condition or long-term use, by driving the motor according to an input speed signal, detecting a driving waveform of the driven motor, synchronizing the detected driving waveform with the speed signal, and controlling the speed of the motor.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus for controlling a motor which receives a speed signal for specifying a speed of the motor as a periodical signal, the apparatus comprising:
a driving waveform detection unit which detects a driving waveform of the motor;
a clock circuit which measures periods of the speed signal and the driving waveform; and
a control unit which drives the motor according to the received speed signal, synchronizing the driving waveform detected by the driving waveform detection unit with the speed signal using the periods of the speed signal and the driving waveform, which are measured by the clock circuit, and controlling the speed of the motor.

2. The apparatus according to claim 1, wherein the speed signal is a pulse signal having a frequency that is proportional to the speed of the motor.

3. The apparatus according to claim 2, wherein the driving waveform detection unit detects at least one of a current waveform and a voltage waveform input to the motor.

4. The apparatus according to claim 3, wherein the clock circuit is a built-in clock circuit which is included in the control unit.

5. The apparatus according to claim 4, wherein the control unit synchronizes the driving waveform with the speed signal of the motor based on the number of revolutions of the motor.

6. The apparatus according to claim 5, wherein the control unit compares a first time corresponding to a number of the periods of the speed signal and a second time corresponding to a number of the periods of the driving waveform when the number of revolutions of the motor which is measured by the clock circuit is one, and controls the speed of the motor according to the result of comparison.

7. The apparatus according to claim 6, wherein the control unit decreases the speed of the motor when the first time is greater than the second time, increases the speed of the motor when the first time is less than the second time, and maintains the speed of the motor when the first time is identical to the second time.

8. A method for controlling a motor, the method comprising:
receiving a speed signal specifying a speed of the motor as a periodical signal;
driving the motor according to the received speed signal;
detecting a driving waveform of the driven motor; and
synchronizing the detected driving waveform with the speed signal and controlling the speed of the motor.

9. The method according to claim 8, wherein the speed signal is a pulse signal having a frequency that is proportional to the speed of the motor.

10. The method according to claim 9, wherein the detected driving waveform is at least one of a current waveform and a voltage waveform input to the motor.

11. The method according to claim 10, wherein the synchronizing of the detected driving waveform comprising:
synchronizing the driving waveform with the speed signal of the motor based on the number of revolutions of the motor.

12. The method according to claim 11, wherein the synchronizing of the detected driving waveform further comprises:
measuring a first time corresponding to the number of periods of the speed signal and a second time corresponding to the number of periods of the driving waveform when the number of revolutions of the motor is one; and
comparing the first and second times which are measured and controlling the speed of the motor according to the result of comparison.

13. The method according to claim 12, wherein the comparing of the first and second times comprises:
decreasing the speed of the motor when the first time is greater than the second time;
increasing the speed of the motor when the first time is less than the second time; and
maintaining the speed of the motor when the first time is identical to the second time.

14. An apparatus for controlling a motor, the apparatus comprising:
an external speed signal input unit to input a speed signal corresponding to a speed of the motor;
a motor driving unit to drive the motor;
a control unit to transmit a control signal for driving the motor to the motor driving unit, and to measure a first period of the speed signal using a clock circuit so as to obtain a target rotational speed of the motor and to generate the control signal to drive the motor at the obtained rotational speed using information stored in memory; and
a motor driving waveform detection circuit which detects and transmits a driving waveform of the motor to the control signal, wherein the control unit measures a second period of the transmitted driving waveform using the clock circuit and controls the speed of the motor based on the period of the driving waveform.

15. The apparatus according to claim 14, wherein the driving waveform of the motor is at least one of phase current and phase voltage input to the motor.

16. The apparatus according to claim 14, wherein the rotational speed of the motor is controlled by synchronizing the speed signal input with the driving waveform based upon a revolution of the motor.
